(19) United States
(12) Patent Application Publication
(10) Pub. No.: US 2012/0025523 A1
(43) Pub. Date: Feb. 2, 2012

(54) QUICK JOINT IN HYDRAULIC PIPELINE

(75) Inventors: Zongyuan Zhu, Ruian City (CN); Xu Chen, Ruian City (CN)

(73) Assignee: RUILI GROUP RUIAN AUTO PARTS CO., LTD., Ruian City (CN)

(21) Appl. No.: 13/177,193

(22) Filed: Jul. 6, 2011

(30) Foreign Application Priority Data
Jul. 30, 2010 (CN) 201020276407.4

(51) Int. Cl. F16L 37/30; F16L 21/02; F16L 37/00

(52) U.S. Cl. 285/374

(57) ABSTRACT

A quick joint in a hydraulic pipeline, more particularly, a quick pipeline joint applied to a hydraulic system, where frequent disconnection or connection of liquid pipelines is required. In one embodiment, the quick joint in the hydraulic pipeline includes an outer joint and an inner joint. The outer joint includes an oil pipe joint, O-rings, a block, a spring, a valve rod, a plunger, a joint sleeve and other parts. The inner joint includes a plurality of O-rings, a spring seat, a joint sleeve, a spring, an oil pipe joint and other parts. The outer joint and the inner joint can be connected or disconnected easily through insertion and pull-out of a circlip.

### CROSS-REFERENCE TO RELATED APPLICATIONS

This non-provisional application claims priority under 35 U.S.C. §119(a) on Patent Application No. 201020276407.4 filed in China on Jul. 30, 2010, the entire contents of which are hereby incorporated by reference.

### FIELD OF THE INVENTION

The present invention relates to the technical field of a quick joint in a hydraulic pipeline and is applicable in a hydraulic system, where frequent disconnection or connection of liquid pipelines are required, for example, connection of a low-pressure liquid pipeline such as a vehicle clutch hydraulic pipeline.

### BACKGROUND OF THE INVENTION

In a hydraulic pipeline system, a hydraulic pipeline joint requires a high tightness.

Currently, a spiral pipe joint and a welded hinged pipe joint are most common ones, for example, the China Utility Model Patent No. 200820184953 entitled “ROTARY PIPE JOINT ASSEMBLY OF HYDRAULIC SYSTEM” and the China Patent Application No. 200810231487 entitled “UNIVERSAL HYDRAULIC PIPE JOINT AND DESIGN THEREOF”. The above two pipe joints technically focus on ensuring the tightness.

However, the replacement is inconvenient, and therefore the two pipe joints are not applicable when frequent disconnection or connection of liquid pipelines are required.

### SUMMARY OF THE INVENTION

Accordingly, in one aspect, the present invention is directed to a quick joint in a hydraulic pipeline, in which two parts of structures, an inner joint and an outer joint are adopted. The outer joint can be easily separated from the inner joint. No liquid flows out after the outer joint and the inner joint are separated. Therefore, during the assembly and disassembly, no liquid flows away and the air is prevented from getting in, so the present invention is applicable to various types of hydraulic pipelines.

In one embodiment, a quick joint in a hydraulic pipeline is provided, which includes two parts: an outer joint and an inner joint, so as to realize connection and disconnection of the pipelines through the connection and disconnection of the inner joint and the outer joint.

Preferably, the outer joint includes an oil pipe joint 1, O-rings 2, 7 and 8, a block 3, a spring 4, a valve rod 5, a plunger 6, a joint sleeve 9 and other parts. The left end of the oil pipe joint 1 is connected to an oil hose. When a liquid enters an inner cavity of the joint, the three O-rings 2, 7 and 8 form a closed cavity so that no liquid leaks. The oil pipe joint 1 is edged and riveted by the left end of the joint sleeve 9 and cannot fall off or become loose. The valve rod 5 is riveted to an inner hole of the block 3 and cannot fall off.

Preferably, the inner joint includes O-rings 10, 11 and 15, a spring seat 12, a joint sleeve 13, a spring 14, an oil pipe joint 16 and other parts. The oil pipe joint 16 is edged and riveted by the right end of the joint sleeve 13 and cannot fall off or become loose. The right end of the oil pipe joint 16 is connected to the oil hose. When a liquid enters the inner cavity of the joint, the three O-rings 10, 11 and 15 form a closed cavity so that the liquid cannot leak.

The beneficial effects of the present invention, among other things, are as follows.

1. The connection and disconnection of the joints can be operated in a simple, convenient, and reliable manner. The quick joint in the hydraulic pipeline according to the present invention is constructed by the inner joint and the outer joint, and therefore the connection and disconnection operations can be achieved only through insertion and pull-out of a circlip.

2. When the pipeline is disconnected, no liquid leaks from the separated outer and inner joints. The liquid is sealed completely in the pipeline so that during assembly and disassembly, the liquid does not flow away and the air is prevented from getting in.

3. The oil pipe joints of the outer joint and the inner joint may adopt different ways of connection as required, so as to be applicable to various kinds of pipeline connections.

These and other aspects of the present invention will become apparent from the following description of the preferred embodiment taken in conjunction with the following drawings, although variations and modifications therein may be effected without departing from the spirit and scope of the novel concepts of the disclosure.

### BRIEF DESCRIPTION OF THE DRAWINGS

The accompanying drawings illustrate one or more embodiments of the invention and together with the written description, serve to explain the principles of the invention. Wherever possible, the same reference numbers are used throughout the drawings to refer to the same or like elements of an embodiment, and wherein:

FIG. 1A and FIG. 1B respectively are schematic structural views of an outer joint and an inner joint according to a preferred embodiment of the present invention;

FIG. 2A is a schematic structural view of a state when the inner joint is connected to the outer joint according to a preferred embodiment of the present invention;

FIG. 2B is a schematic structural view of a cross-section of the connection where the inner joint is connected to the outer joint according to a preferred embodiment of the present invention;

FIG. 3A and FIG. 3B respectively are schematic structural views of the outer joint and the inner joint, when used to connect two non-metallic pipes, according to the preferred embodiment of the present invention;

FIG. 4A and FIG. 4B respectively are schematic structural views of the outer joint and the inner joint, when used to connect a non-metallic pipe to a metallic rigid pipe, according to the preferred embodiment of the present invention;

FIG. 5A and FIG. 5B respectively are schematic structural views of the outer joint and the inner joint, when used to connect a metallic rigid pipe to a non-metallic pipe, according to the preferred embodiment of the present invention; and

FIG. 6A and FIG. 6B respectively are schematic structural views of the outer joint and the inner joint, when used to connect two metallic rigid pipes, according to the preferred embodiment of the present invention.

### DETAILED DESCRIPTION OF THE INVENTION

The present invention is more particularly described in the following examples that are intended as illustrative only since numerous modifications and variations therein will be apparent to those skilled in the art. Various embodiments of the invention are now described in detail. Referring to the drawings, like numbers indicate like components throughout the views. As used in the description herein and throughout the claims that follow, the meaning of “a”, “an”, and “the” includes plural reference unless the context clearly dictates otherwise. Also, as used in the description herein and throughout the claims that follow, the meaning of “in” includes “in” and “on” unless the context clearly dictates otherwise.

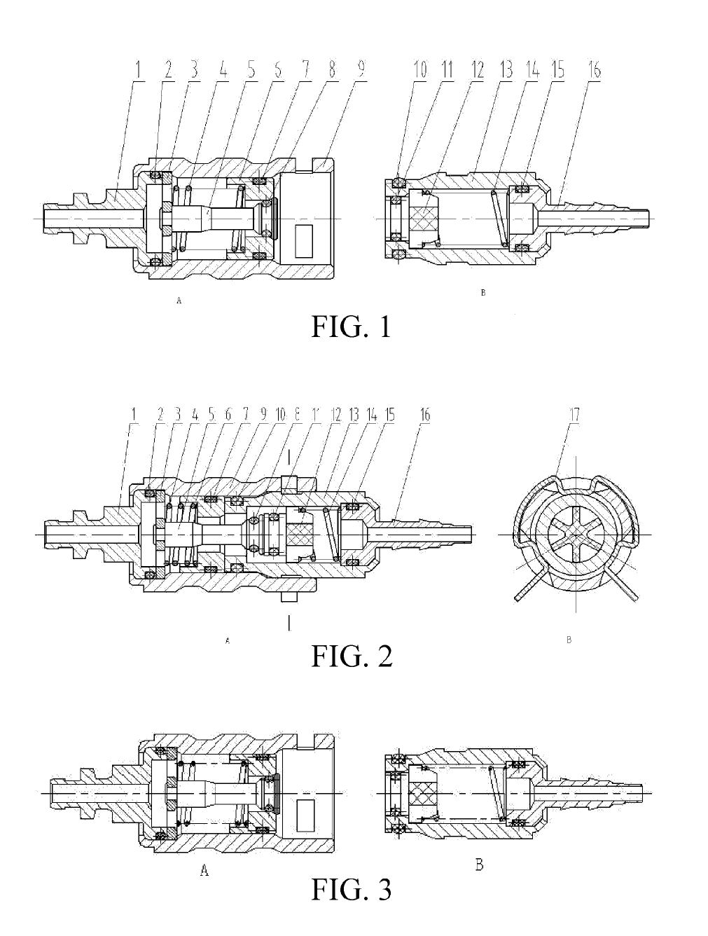

As shown in FIG. 1A and FIG. 1B, a quick joint in a hydraulic pipeline includes two parts: an outer joint and an inner joint, so as to realize connection and disconnection of the pipelines through the connection and disconnection of the inner joint and the outer joint.

The outer joint includes an oil pipe joint 1, O-rings 2, 7 and 8, a block 3, a spring 4, a valve rod 5, a plunger 6, a joint sleeve 9 and other parts. The left end of the oil pipe joint 1 is connected to an oil hose. When a liquid enters an inner cavity of the joint, the three O-rings 2, 7 and 8 form a closed cavity so that no liquid leaks. The oil pipe joint 1 is edged and riveted by the left end of the joint sleeve 9 and cannot fall off or become loose. The valve rod 5 is riveted to an inner hole of the block 3 and cannot fall off.

The inner joint includes O-rings 10, 11 and 15, a spring seat 12, a joint sleeve 13, a spring 14, an oil pipe joint 16 and other parts. The oil pipe joint 16 is edged and riveted by the right end of the joint sleeve 13 and cannot fall off or become loose. The right end of the oil pipe joint 16 is connected to the oil hose. When a liquid enters the inner cavity of the joint, the three O-rings 10, 11 and 15 form a closed cavity so that the liquid cannot leak.

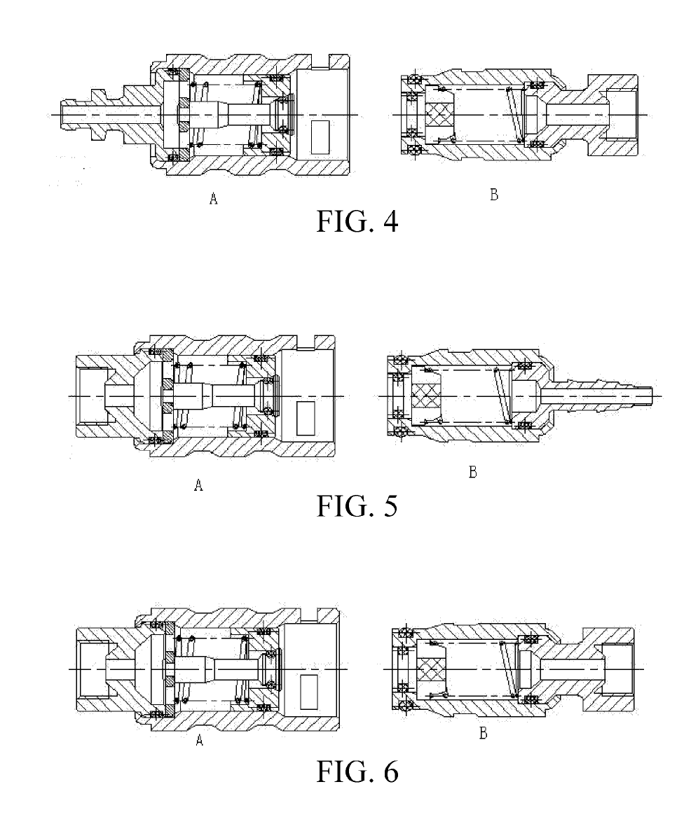

When the joint according to one embodiment of the present invention is used for the pipeline connection in a hydraulic system, as shown in FIG. 2A and FIG. 2B, the outer joint is connected to the inner joint. When used for the oil pipeline connection, the left end of the inner joint is inserted into the right end of the outer joint, the joint sleeve 13 pushes the plunger 6 to move leftward so that the O-rings 7 and 10 are tightly joined to the hole wall and get sealed. The valve rod 5 remains at the same position and holds against the spring seat 12 when the joint sleeve 13 moves leftward, so that both the O-rings 8 and 11 are separated from the hole wall. When the circlip groove of the joint sleeve 13 moves in parallel with the circlip groove of the joint sleeve 9, a circlip 17 is inserted into the groove to realize the connection of the oil pipe. At this time, the oil pipe joints at the two ends are completely connected. Only the circlip 17 and the inner joint need to be pulled out when the pipeline needs to be disconnected. Under the force of the springs 4 and 14, the outer joint and the inner joint can return to the states in FIG. 1A and FIG. 1B and become two independent and closed pipelines. Both the oil pipe joints of the outer joint and the inner joint can be conveniently connected to the hydraulic pipeline. The quick joint according to one embodiment of the present invention is applicable to connection of a low-pressure liquid pipeline, such as a vehicle clutch hydraulic pipeline, and also applicable to situations when frequent disconnection or connection of liquid pipelines are required. The connecting method of the oil pipe joints can be widely applied to many kinds of situations, for example, connection of two non-metallic hydraulic pipelines as shown in FIG. 3A and FIG. 3B, connection of a non-metallic hydraulic pipeline and a metallic rigid pipe as shown in FIG. 4A and FIG. 4B, connection of a metallic rigid pipe and a non-metallic hydraulic pipeline as shown in FIG. 5A and FIG. 5B, and connection of two metallic rigid pipes. The foregoing description of the exemplary embodiments of the invention has been presented only for the purposes of illustration and description and is not intended to be exhaustive or to limit the invention to the precise forms disclosed. Many modifications and variations are possible in light of the above teaching.

The embodiments are chosen and described in order to explain the principles of the invention and their practical application so as to activate others skilled in the art to utilize the invention and various embodiments and with various modifications as are suited to the particular use contemplated. Alternative embodiments will become apparent to those skilled in the art to which the present invention pertains without departing from its spirit and scope. Accordingly, the scope of the present invention is defined by the appended claims rather than the foregoing description and the exemplary embodiments described therein.

What is claimed is:

1. A quick joint in a hydraulic pipeline, comprising an outer joint and an inner joint.

2. The quick joint in the hydraulic pipeline according to claim 1, wherein
the outer joint comprises an oil pipe joint (1), O-rings (2, 7 and 8), a block (3), a spring (4), a valve rod (5), a plunger (6), and a joint sleeve (9);
a left end of the oil pipe joint (1) is connected to an oil pipeline;
the oil pipe joint (1) is edged and riveted by a left end of the joint sleeve (9); and
the valve rod (5) is riveted to an inner hole of the block (3).

3. The quick joint in the hydraulic pipeline according to claim 1, wherein
the inner joint comprises O-rings (10, 11 and 15), a spring seat (12), a joint sleeve (13), a spring (14), and an oil pipe joint (16);
the oil pipe joint (16) is edged and riveted by a right end of the joint sleeve (13); and
a right end of the oil pipe joint (16) is connected to an oil hose.

4. The quick joint in the hydraulic pipeline according to claim 1, wherein both the outer joint and the inner joint are connected by inserting an elastic circlip into a circlip groove.
